(19) United States
(12) Patent Application Publication
(10) Pub. No.: US 2011/0244388 A1
(43) Pub. Date: Oct. 6, 2011

(54) RESIN-COATED CARRIER FOR ELECTROPHOTOGRAPHIC DEVELOPER, AND ELECTROPHOTOGRAPHIC DEVELOPER USING THE RESIN-COATED CARRIER

(75) Inventors: Tetsuya UEMURA, Kashiwa-shi (JP); Tomoaki KOBAYASHI, Kashiwa-shi (JP); Masashi AOKI, Sakura-shi (JP)

(73) Assignee: POWDERTECH CO., LTD., Chiba (JP)

(21) Appl. No.: 13/071,830

(22) Filed: Mar. 25, 2011

(30) Foreign Application Priority Data
Mar. 30, 2010 (JP) 2010-078563

(51) Int. Cl. G03G 9/00

(52) U.S. Cl. 430/111.1

(57) ABSTRACT

There is provided a resin-coated carrier for an electrophotographic developer, including: a carrier core particle; and a coating resin layer comprising a silicone resin or a modified silicone resin formed on a surface of the carrier core particle, wherein a titanium-ethyl acetoacetate chelate or a titanium-octylene glycol chelate is contained in the coating resin layer as a titanium chelate, and wherein the content of the titanium-ethyl acetoacetate chelate or the titanium-octylene glycol chelate is 5.0 to 50.0% by weight based on coating resin solids. There is also provided an electrophotographic developer using the resin-coated carrier.

### BACKGROUND OF THE INVENTION

1. Field of the Invention

The present invention relates to a resin-coated carrier for an electrophotographic developer used for a two-component electrophotographic developer used in copying machines, printers, and the like, and to an electrophotographic developer using the resin-coated carrier.

2. Description of the Related Art

In an electrophotographic development system, carrier particles must always cause toner particles to be triboelectrically charged with a desired polarity to a sufficient charge amount during a prolonged use. However, by a collision between carrier particles, mechanical stirring in a developer box, or generation of heat by the collision and the stirring, the toner is fused to the surface of the carrier particles to produce a phenomenon, so called “toner-spent”, and a resin coating is released due to these stresses, thereby reducing the charge properties of the carrier particles with the operating time. Since this causes image quality deterioration such as fogging and toner scattering, it will be necessary to exchange the whole developer.

A coating resin which is relatively useful to the occurrence of toner-spent is a fluororesin. However, since the fluororesin has a low film strength and poor adhesiveness to carrier core particles, the film is often released to reduce the resistance to a level that is excessively low, making it difficult for the initial image characteristics to be maintained.

On the other hand, various carriers using a silicone resin having a low surface energy as a coating resin are proposed. For example, the following proposals have been made.

Japanese Patent Laid-Open No. 06-118725 proposes an electrophotographic magnetic carrier in which the surface of a core particle, which is a composite particle comprising a ferromagnetic particulate and a resin, is coated with a silicone resin containing a conductive substance. This patent application claims that the electrophotographic magnetic carrier has high durability and high image quality, is provided with adaptability to high speed machines and environmental stability, and is free from color stains, and further claims that the charging can be controlled according to various types of toner.

Japanese Patent Laid-Open No. 05-341581 discloses a developer comprising a mixture of resin-coated magnetic particles and toner particles, wherein a resin coating layer of the magnetic particles is composed of a silicone resin, and the resin coating layer contains a coupling agent. Japanese Patent Laid-Open No. 05-341581 claims that the disclosed developer has high developing ability, prevents adhesion of the toner particles to the surface of carrier particles due to prolonged stirring, and is excellent in durability, and further claims that, as a result, when the developer according to Japanese Patent Laid-Open No. 05-341581 is applied to a method of developing an electrostatic latent image while applying an alternate electric field between a latent image carrier and a developer carrier, there will be obtained a high quality image excellent in fine line reproducibility, having no ground fogging, and weak in an edge effect.

Japanese Patent Laid-Open No. 2000-162827 discloses a magnetic carrier for an electrophotographic developer comprising magnetic powder particles, the particle surface of which being coated with a resin composition comprising a metal-based curing agent, a silane coupling agent oligomer, and a silicone resin. According to Japanese Patent Laid-Open No. 2000-162827, such a magnetic carrier is excellent in durability and has a stable electrostatic property.

Japanese Patent Laid-Open No. 2000-181146 proposes an electrostatic charge image developing carrier comprising core particles, wherein the core particles are coated with a coating resin containing a Ti compound or an Al compound in a resin composed of a methyl phenyl silicone polymer having a specific structural unit, for the purpose of improving the environmental stability of the charge amount and improving the reduction in the image maintenance properties caused by the change of an electrostatic property.

Japanese Patent Laid-Open No. 2001-92189 discloses a carrier for an electrophotographic developer comprising a carrier core, wherein the surface of the carrier core is coated with a silicone resin containing an organic titanium catalyst so that the change of resistance, a charge amount, and fluidity can be reduced, and the initial image characteristics can be maintained even after endurance printing for a long time. According to this patent application, a titanium monomer catalyst, a titanium chelate catalyst, and the like can be mentioned as the organic titanium catalyst, and the content thereof is preferably 0.5 to 3.0% by weight of the silicone resin.

However, the conventional arts as described above are unsatisfactory to extend the service life of a carrier against the change of toner, image forming devices such as copying machines, and the like, accompanying the requirement of higher image quality in recent years. It is possible to propose a carrier having excellent durability or stable characteristics as a result of effective action of a coupling agent or a curing agent on a silicone resin. However, if an additive is added in a larger amount with the expectation of the effect of the additive, the strength of a coating resin will be reduced to cause the release of the resin, resulting in an adverse effect.

Thus, a resin-coated carrier coated with a silicone resin or a modified silicone resin also has not yet provided a carrier that has an extended service life, that is, has high durability, shows little reduction in the charge amount even after a prolonged use, and is excellent in the environmental stability of the charge amount.

### SUMMARY OF THE INVENTION

Accordingly, it is an object of the present invention to provide a resin-coated carrier for an electrophotographic developer which has solved the conventional problems as described above; which has high durability, shows little reduction in the charge amount even after a prolonged use, and is excellent in the environmental stability of the charge amount; and which broadly corresponds to the printing rate variation and toner density variation accompanying full colorization and provides a stable image quality, and to provide an electrophotographic developer using the same.

The present inventors have found, as a result of intensive investigation, that the problems as described above can be solved by using a silicone resin or a modified silicone resin as a coating resin and by further containing a certain amount of a specific titanium chelate in the coating resin. These findings have led to the completion of the present invention.

Specifically, the present invention provides a resin-coated carrier for an electrophotographic developer, comprising: a carrier core particle; and a coating resin layer comprising a silicone resin or a modified silicone resin formed on a surface of the carrier core particle, wherein a titanium-ethyl acetoacetate chelate or a titanium-octylene glycol chelate is contained in the coating resin layer as a titanium chelate, and wherein the content of the titanium-ethyl acetoacetate chelate or the titanium-octylene glycol chelate is 5.0 to 50.0% by weight based on coating resin solids.

The resin-coated carrier for an electrophotographic developer according to the present invention preferably contains a charge control agent, an adhesion improver, and a crosslinking agent in the coating resin layer.

In the resin-coated carrier for an electrophotographic developer according to the present invention, it is preferred that the charge control agent be an aminosilane coupling agent, the content thereof being 1.0 to 30.0% by weight based on coating resin solids; the adhesion improver be an epoxy group-containing silane coupling agent, the content thereof being 0.05 to 10.0% by weight based on coating resin solids; and the crosslinking agent be methyltris(methylethylketoxime)silane (MTO) and/or vinyltris(methylethylketoxime)silane (VTO), the content thereof being 0.05 to 10.0% by weight based on coating resin solids.

The present invention also provides an electrophotographic developer comprising the above resin-coated carrier and toner.

The electrophotographic developer according to the present invention is also used as a refill developer.

The resin-coated carrier for an electrophotographic developer according to the present invention and the electrophotographic developer using the same provide high durability, show little reduction in the charge amount even after a prolonged use, and are excellent in the environmental stability of the charge amount, and broadly correspond to the printing rate variation and toner density variation accompanying full colorization and provide a stable image quality.

### DETAILED DESCRIPTION OF THE EMBODIMENTS

Hereinafter, the embodiments for accompanying the present invention will be described.

### <The Resin-Coated Carrier for an Electrophotographic Developer According to the Present Invention>

The resin-coated carrier for an electrophotographic developer according to the present invention comprises carrier core particles and a coating resin layer comprising a silicone resin or a modified silicone resin formed on the surface of the carrier core particles.

The carrier core particles used here include an iron powder core, a magnetite core, a resin carrier core, and a ferrite core, which have been used as a carrier core (particle) for an electrophotographic developer. Among them, a ferrite core composed of ferrite particles containing at least one selected from among Mn, Mg, Li, Ca, Sr, and Ti is particularly desirable. When the recent trend of reducing the environmental load including the waste regulation is taken into consideration, it is preferred that heavy metals such as Cu, Zn, and Ni be not contained in an amount exceeding the content of inevitable impurities (concomitant impurities).

When the carrier core particles comprise a ferrite core composed of ferrite particles, ferrite particles having high porosity can also be used. In this case, the ferrite particles can be used as a resin-filled ferrite carrier in which the voids of the ferrite particles are filled with a resin.

The volume average particle diameter (D₅₀) of the carrier core particles is desirably in the range of 15 to 80 μm. In this range, carrier beads carry over is prevented and good image quality is obtained. If the average particle size is less than 15 μm, the carrier beads carry over will tend to occur, and therefore, this is not preferred. Further, if the average particle size exceeds 80 μm, image quality will tend to deteriorate, and therefore, this is not preferred.

### (Average Particle Size)

The average particle size is measured with a Microtrac Particle Size Analyzer (model 9320-X100) manufactured by Nikkiso Co., Ltd. Water is used as a dispersion medium. In a 100 ml beaker, 10 g of a sample and 80 ml of water are placed, and a few drops of a dispersant (sodium hexametaphosphate) are added to the beaker. Next, the mixture thus obtained is dispersed for 20 seconds with an ultrasonic homogenizer (model UH-150, manufactured by SMT Co., Ltd.) set at an output level of 4. Thereafter, the foam formed on the surface of the dispersed mixture in the beaker is removed and the sample is charged into the measurement apparatus.

As described above, a silicone resin or a modified silicone resin is used as a coating resin. More specifically, the coating resin includes an unmodified straight silicone resin and modified silicone resins modified with a resin such as an acrylic resin, a polyester resin, an epoxy resin, a polyamide resin, a polyamide-imide resin, an alkyd resin, a urethane resin and a fluororesin.

The coating amount of the silicone resin or the modified silicone resin based on the carrier core particles is desirably 0.1 to 3.5% by weight based on the carrier core particles when the resin is used for a resin-coated carrier. If the coating amount of the resin is less than 0.1% by weight, the state of toner-spent will deteriorate and the charge amount will decrease with time. If the coating amount of the resin exceeds 3.5% by weight, aggregation between particles will occur, and the state of spent toner will deteriorate. Further, when the resin is used for a resin-filled ferrite carrier as described above, the amount of resin is desirably 5.0 to 20.0% by weight based on the ferrite carrier core particles. The amount of the resin in this case is the sum of the filling amount into the voids of particles and the coating amount which coats the surface of the particles. Note that, as the resin for filling, a resin different from a silicone resin or a modified silicone resin may be used.

In the resin-coated carrier for an electrophotographic developer according to the present invention, a titanium ethyl acetoacetate chelate or a titanium octylene glycol chelate is contained in the coating resin layer as a titanium chelate. Specifically, titanium diisopropoxy bis(ethyl acetoacetate) and titanium dioctyloxy bis(octylene glycolate) are mentioned. If a titanium chelate other than those described above, for example, a titanium acetylacetone chelate is used, the environmental stability of the charge amount will be reduced; the change of the charge amount relative to the printing rate variation and toner density variation will be increased; and stable image quality will not be obtained.

The content of the titanium chelate is 5.0 to 50.0% by weight based on coating resin solids. If the content of the titanium chelate is less than 5.0% by weight, the environmental stability of the charge amount will be reduced, and stable image quality will not be obtained. Further, if the content of the titanium chelate exceeds 50.0% by weight, the silicone resin or the modified silicone resin coating the carrier surface will become brittle to reduce durability, causing reduction in the charge amount.

In the resin-coated carrier for an electrophotographic developer according to the present invention, a charge control agent, an adhesion improver, and a crosslinking agent are desirably contained in the coating resin layer.

As the charge control agent, various charge control agents and various silane coupling agents which are generally used for toner are mentioned. The type of the charge control agent which can be used is not particularly limited, but an aminosilane coupling agent is particularly preferred. The content of the aminosilane coupling agent is desirably 1.0 to 30.0% by weight based on coating resin solids. If the content of the aminosilane coupling agent is less than 1.0% by weight, it will be hard to develop the effect of containing the aminosilane coupling agent, and a proper charge amount will not be obtained. If the content of the aminosilane coupling agent exceeds 30.0% by weight, the silicone resin or the modified silicone resin coating the carrier surface will become brittle to reduce durability, causing reduction in the charge amount.

The adhesion improver is desirably, but is not limited to, an epoxy group-containing silane coupling agent. The content of the epoxy group-containing silane coupling agent is desirably 0.05 to 10.0% by weight based on coating resin solids. If the content of the epoxy group-containing silane coupling agent is less than 0.05% by weight, the adhesiveness between the carrier core particles and the silicone resin or the modified silicone resin will be weak, reducing the charge amount. Further, if the content of the epoxy group-containing silane coupling agent exceeds 10.0% by weight, the adhesiveness between the carrier core particles and the silicone resin or the modified silicone resin can be maintained, but the environmental stability of the charge amount will be reduced; the change of the charge amount relative to the printing rate variation and toner density variation will be increased; and stable image quality will not be obtained.

As the crosslinking agent, ketoxime silane compounds such as methyltris(methylethylketoxime)silane (MTO) and vinyltris(methylethylketoxime)silane (VTO) can be used. The MTO and VTO can be used alone or in combination. If the crosslinking agent is different from those illustrated above, the silicone resin or the modified silicone resin coating the surface of the carrier core particles will become brittle to reduce durability, and there will be concern of causing reduction in the charge amount.

The content of the crosslinking agent is desirably 0.05 to 10.0% by weight based on coating resin solids. If the content of the crosslinking agent is less than 0.05% by weight, the silicone resin or the modified silicone resin coating the surface of the carrier core particles will become brittle to reduce durability, and there will be concern of causing reduction in the charge amount. Further, if the content of the crosslinking agent exceeds 10.0% by weight, the change of the charge amount relative to the printing rate variation and toner density variation will be increased, and stable image quality will not be obtained.

In the present invention, a conductive agent can be contained in the coating resin layer for the purpose of controlling the electrical resistance, the charge amount, and the charging speed of a carrier. Since a conductive agent itself has a low electrical resistance, an excessively high content of the conductive agent will tend to cause a significant charge leak. Accordingly, the content of the conductive agent is 0.25 to 20.0% by weight, preferably 0.5 to 15.0% by weight, based on coating resin solids. As the conductive agent, such as conductive carbon, titanium oxide, and tin oxide, and various types of organic conductive agents are mentioned.

### <The Electrophotographic Developer According to the Present Invention>

Next, the electrophotographic developer according to the present invention will be described.

The electrophotographic developer according to the present invention comprises the above-described carrier for an electrophotographic developer and toner.

The toner particles which constitute the electrophotographic developer of the present invention include pulverized toner particles produced by a pulverizing method and polymerized toner particles produced by a polymerization method. In the present invention, the toner particles obtained by either method can be used.

The pulverized toner particles can be obtained, for example, as follows. A binder resin, a charge control agent, and a colorant are sufficiently mixed in a mixer such as a Henschel mixer. The resulting mixture is melt-kneaded in a twin screw extruder or the like, cooled, pulverized, and classified. Thereafter, an external additive is added to the classified mixture followed by mixing in a mixer or the like.

The binding resin which constitutes the pulverized toner particles can include, but is not limited to, polystyrene, chloropolystyrene, a styrene-chlorostyrene copolymer, a styrene-acrylic ester copolymer, a styrene-methacrylic acid copolymer, a rosin-modified maleic resin, an epoxy resin, a polyester resin, and a polyurethane resin. These can be used alone or in combination.

As the charge control agent, any charge control agent can be used. For example, as the charge control agent for a positively charged toner, nigrosine dye and a quaternary ammonium salt and the like can be mentioned, and as the charge control agent for a negatively charged toner, a metal-containing monoazo dye and the like can be mentioned.

As the colorant (coloring material), conventionally known dyes and pigments can be used. For example, carbon black, phthalocyanine blue, permanent red, chrome yellow, phthalocyanine green and the like can be used. Other than these, an external additive such as silica powder and titania can be added depending upon the type of toner particles in order to improve fluidity and aggregation resistance of the toner particles.

The polymerized toner particles are produced by a known method such as a suspension polymerization method, an emulsion polymerization method, an emulsion aggregation method, an ester elongation polymerization method, and a phase inversion emulsification method. Such polymerized toner particles can be obtained, for example, as follows. A colorant dispersion, in which a colorant is dispersed in water using a surfactant, is mixed with a polymerizable monomer, a surfactant, and a polymerization initiator in an aqueous medium while stirring to emulsify and disperse the polymerizable monomer in the aqueous medium. After the monomer is polymerized while stirring and mixing, a salting agent is added to salt out polymer particles. The particles obtained by salting are filtered, washed, and dried to obtain the polymerized toner particles. Thereafter, an external additive is optionally added to the dried toner particles.

Further, in producing the polymerized toner particles, in addition to a polymerizable monomer, a surfactant, a polymerization initiator, and a colorant, a fixability improving agent and a charge control agent can be blended. These agents can control and improve various properties of the resulting polymerized toner particles. Furthermore, a chain transfer agent can be used to improve dispersibility of a polymerizable monomer in an aqueous medium and adjust the molecular weight of the resulting polymer.

The polymerizable monomer used for producing the polymerized toner particles as described above is not particularly limited, and examples thereof can include styrene and derivatives thereof, ethylene unsaturated monoolefins such as ethylene and propylene, vinyl halides such as vinyl chloride, vinyl esters such as vinyl acetate, and α-methylene aliphatic monocarboxylates such as methyl acrylate, ethyl acrylate, methyl methacrylate, ethyl methacrylate, 2-ethylhexyl methacrylate, dimethylamino acrylate, and diethylamino methacrylate.

As the colorant (coloring material) used for preparing the polymerized toner particles as described above, conventionally known dyes and pigments can be used. For example, carbon black, phthalocyanine blue, permanent red, chrome yellow, phthalocyanine green and the like can be used. Furthermore, the surface of these colorants may be improved using a silane coupling agent, a titanium coupling agent, or the like.

As the surfactant used for producing the polymer toner particles as described above, an anionic surfactant, a cationic surfactant, an amphoteric surfactant, and a nonionic surfactant can be used.

Here, examples of the anionic surfactant include an aliphatic acid salt such as sodium oleate and castor oil, an alkyl sulfate such as sodium lauryl sulfate and ammonium lauryl sulfate, an alkyl benzene sulfonate such as sodium dodecyl benzenesulfonate, an alkyl naphthalene sulfonate, an alkyl phosphate, a naphthalene sulfonate-formalin condensation product, and a polyoxyethylene alkyl sulfate. Furthermore, examples of the nonionic surfactant include a polyoxyethylene alkyl ether, a polyoxyethylene fatty acid ester, a sorbitan fatty acid ester, a polyoxyethylene alkylamine, glycerin, a fatty acid ester, and an oxyethylene-oxypropylene block polymer. Furthermore, examples of the cationic surfactant include an alkyl amine salt such as lauryl amine acetate and a quaternary ammonium salt such as lauryl trimethylammonium chloride and stearyl trimethylammonium chloride. Furthermore, examples of the amphoteric surfactant include an aminocarboxylic acid salt and an alkyl amino acid.

The surfactant as described above can be used typically in an amount in the range of 0.01 to 10% by weight based on the polymerizable monomer. The amount of the surfactant to be used affects the dispersion stability of a monomer and dependence of the resulting polymer toner particles on the environment. For this reason, the surfactant is preferably used in an amount in the above-described range in which the dispersion stability of the monomer can be ensured and the dependence of the resulting polymer toner particles on the environment is not excessively affected.

A polymerization initiator is generally used for producing polymerized toner particles. The polymerization initiator includes a water-soluble polymerization initiator and an oil-soluble polymerization initiator. Either polymerization initiator can be used in the present invention. Examples of the water soluble polymerization initiator that can be used in the present invention include a persulfate salt such as potassium persulfate and ammonium persulfate and a water-soluble peroxide compound, and examples of the oil-soluble polymerization initiator include an azo compound such as azobisisobutyronitrile and an oil-soluble peroxide compound.

Further, when a chain transfer agent is used in the present invention, examples of the chain transfer agent include mercaptans such as octyl mercaptan, dodecyl mercaptan and tert-dodecyl mercaptan and carbon tetrabromide.

Furthermore, when the polymerized toner particles to be used in the present invention contain a fixability improving agent, examples of the fixability improving agent include a natural wax such as carnauba wax and a wax of an olefin such as polypropylene and polyethylene.

Furthermore, when the polymerized toner particles to be used in the present invention contain a charge control agent, examples of the charge control agent to be used include, but are not limited to, nigrosine dye, a quaternary ammonium salt, an organometallic complex, and a metal-containing monoazo dye.

Furthermore, examples of the external additive to be used for improving the fluidity or the like of polymerized toner particles include silica, titanium oxide, barium titanate, fluororesin particulates, and acrylic resin particulates. These can be used alone or in combination.

Furthermore, examples of the salting agent for separating the polymerized toner particles from an aqueous medium include a metal salt such as magnesium sulfate, aluminum sulfate, barium chloride, magnesium chloride, calcium chloride, and sodium chloride.

The average particle size of the toner particles produced as described above is in the range of 2 to 15 μm, preferably 3 to 10 μm. Polymerized toner particles are more uniform in particle size than pulverized toner particles. If the toner particle size is less than 2 μm, chargeability will decrease likely to cause fogging and toner scattering, and if it exceeds 15 μm, image quality will deteriorate.

The carrier produced as described above and toner can be mixed to obtain an electrophotographic developer. The mixing ratio of the toner to the carrier, that is, the toner concentration, is preferably set at 3 to 15% by weight. If the concentration is less than 3% by weight, a desired image density cannot be obtained, and if it exceeds 15% by weight, toner scattering and fogging will be likely to occur.

The electrophotographic developer according to the present invention can also be used as a developer for replenishment. At this time the mixing ratio of the toner to the carrier, that is, the toner concentration, is preferably set at 100 to 3000% by weight.

The electrophotographic developer according to the present invention prepared as described above can be used in a digital copying machine, a printer, FAX, a printing machine, and the like, employing a developing system in which an electrostatic latent image formed on a latent image holder having an organic photoconductor layer is reverse-developed by a magnetic brush of a two component developer having toner and a carrier while applying a bias electric field. The electrophotographic developer can also be applied to a full color machine or the like using an alternating electric field, in which there is used a method of superimposing AC bias on DC bias when a developing bias is applied to an electrostatic latent image from a magnetic brush.

Hereinafter, the present invention will be specifically described with reference to Examples.

### Example 1

Appropriate amounts of raw materials were dry-blended such that the raw materials were contained in an amount of 39.7 mol % in terms of MnO, 9.9 mol % in terms of MgO, 49.6 mol % in terms of Fe₂O₃, and 0.8 mol % in terms of SrO. The resulting mixture was pulverized by a dry vibration mill for 2 hours and granulated by a dry granulator to obtain a granulated product having a size of about 2 cm. The granulated product was calcined using a rotary kiln at 950° C. to obtain a calcined product. The calcined product was again pulverized by a wet ball mill for 2 hours to obtain slurry, which was granulated and dried in a spray dryer to obtain a granulated product. Thus obtained product was sintered at 1300° C. for 3 hours in a tunnel kiln in a nitrogen atmosphere to obtain a sintered product. Then, the sintered product was disintegrated, and the particle size distribution of the disintegrated product was adjusted to obtain a Mn—Mg—Sr ferrite core having an average particle size of 40 μm.

Next, a methyl silicone resin in an amount of 150 g in terms of solids was weighed and dissolved in 300 ml of toluene. Furthermore, 3-aminopropyltriethoxysilane was added as a charge control agent in an amount of 15.0% by weight based on solids of the methyl silicone resin; 3-glycidoxypropyltrimetoxysilane was added as an adhesion improver in an amount of 1.0% by weight based on solids of the methyl silicone resin; titanium diisopropoxy bis(ethyl acetoacetate) was added as a titanium chelate in an amount of 25.0% by weight based on solids of the methyl silicone resin; and methyltris(methylethylketoxime)silane (MTO) was added as a crosslinking agent in an amount of 1.0% by weight based on solids of the methyl silicone resin, respectively, to the mixture to obtain a coating solution.

To 10 kg of the above Mn—Mg—Sr ferrite core was applied the above coating solution using a dip coating apparatus (the coating amount based on the carrier core particles was 1.5% by weight). Thereafter, the resulting resin-coated carrier was baked at 280° C. for 2 hours in a shelved drying chamber and then disintegrated, and the particle size distribution of the disintegrated product was adjusted to obtain a resin-coated carrier for an electrophotographic developer.

The resin-coated carrier and a commercially available black toner (imagioNeoC455 manufactured by Ricoh Company, Ltd.) were weighed so that the resulting developer has a weight of 1 kg and a toner density of 7.5% by weight, and the mixture was stirred for 30 minutes to obtain an electrophotographic developer. When the charge amount of this electrophotographic developer was measured, it was found to be 35.7 μC/g as shown in Table 3.

Furthermore, the above electrophotographic developer was subjected to stirring test for 48 hours with a tabular mixer. The charge amount after 48 hours was 26.1 μC/g as shown in Table 3, showing almost no reduction in the charge amount.

### Example 2

A resin-coated carrier for an electrophotographic developer was produced in the same manner as in Example 1 using the same carrier core particles as used in Example 1 except that titanium diisopropoxy bis(ethyl acetoacetate) was used as a titanium chelate in an amount of 5.0% by weight based on coating resin solids, as shown in Tables 1 and 2.

### Example 3

A resin-coated carrier for an electrophotographic developer was produced in the same manner as in Example 1 using the same carrier core particles as used in Example 1 except that titanium diisopropoxy bis(ethyl acetoacetate) was used as a titanium chelate in an amount of 50.0% by weight based on coating resin solids, as shown in Tables 1 and 2.

### Example 4

A resin-coated carrier for an electrophotographic developer was produced in the same manner as in Example 1 using the same carrier core particles as used in Example 1 except that titanium dioctyloxy bis(octylene glycolate) was used as a titanium chelate in an amount of 25.0% by weight based on coating resin solids, as shown in Tables 1 and 2.

### Example 5

A resin-coated carrier for an electrophotographic developer was produced in the same manner as in Example 1 using the same carrier core particles as used in Example 1 except that N-2 (aminoethyl)-3-aminopropyltrimethoxysilane was used as a charge control agent in an amount of 15.0% by weight based on coating resin solids, as shown in Tables 1 and 2.

### Example 6

A resin-coated carrier for an electrophotographic developer was produced in the same manner as in Example 1 using the same carrier core particles as used in Example 1 except that a quaternary ammonium salt complex was used as a charge control agent in an amount of 15.0% by weight based on coating resin solids, as shown in Tables 1 and 2.

### Example 7

A resin-coated carrier for an electrophotographic developer was produced in the same manner as in Example 1 using the same carrier core particles as used in Example 1 except that titanium dioctyloxy bis(octylene glycolate) was used as a titanium chelate in an amount of 25.0% by weight based on coating resin solids, and a charge control agent was not used, as shown in Tables 1 and 2.

### Example 8

A resin-coated carrier for an electrophotographic developer was produced in the same manner as in Example 1 using the same carrier core particles as used in Example 1 except that 3-aminopropyltriethoxysilane was used as a charge control agent in an amount of 1.0% by weight based on coating resin solids, as shown in Tables 1 and 2.

### Example 9

A resin-coated carrier for an electrophotographic developer was produced in the same manner as in Example 1 using the same carrier core particles as used in Example 1 except that 3-aminopropyltriethoxysilane was used as a charge control agent in an amount of 30.0% by weight based on coating resin solids, as shown in Tables 1 and 2.

### Example 10

A resin-coated carrier for an electrophotographic developer was produced in the same manner as in Example 1 using the same carrier core particles as used in Example 1 except that titanium dioctyloxy bis(octylene glycolate) was used as a titanium chelate in an amount of 25.0% by weight based on solids of the coating resin, and 3-aminopropyltriethoxysilane was used as a charge control agent in an amount of 40.0% by weight based on coating resin solids, as shown in Tables 1 and 2.

### Example 11

A resin-coated carrier for an electrophotographic developer was produced in the same manner as in Example 1 using the same carrier core particles as used in Example 1 except that (3-glycidoxypropyl)methyldiethoxysilane was used as an adhesion improver in an amount of 1.0% by weight based on coating resin solids, as shown in Tables 1 and 2.

### Example 12

A resin-coated carrier for an electrophotographic developer was produced in the same manner as in Example 1 using the same carrier core particles as used in Example 1 except that 2-(3,4-epoxycyclohexyl)ethyltrimethoxysilane was used as an adhesion improver in an amount of 1.0% by weight based on coating resin solids, as shown in Tables 1 and 2.

### Example 13

A resin-coated carrier for an electrophotographic developer was produced in the same manner as in Example 1 using the same carrier core particles as used in Example 1 except that titanium dioctyloxy bis(octylene glycolate) was used as a titanium chelate in an amount of 25.0% by weight based on coating resin solids, and an adhesion improver was not used, as shown in Tables 1 and 2.

### Example 14

A resin-coated carrier for an electrophotographic developer was produced in the same manner as in Example 1 using the same carrier core particles as used in Example 1 except that 3-glycidoxypropyltrimetoxysilane was used as an adhesion improver in an amount of 0.05% by weight based on coating resin solids, as shown in Tables 1 and 2.

### Example 15

A resin-coated carrier for an electrophotographic developer was produced in the same manner as in Example 1 using the same carrier core particles as used in Example 1 except that 3-glycidoxypropyltrimetoxysilane was used as an adhesion improver in an amount of 10.0% by weight based on coating resin solids, as shown in Tables 1 and 2.

### Example 16

A resin-coated carrier for an electrophotographic developer was produced in the same manner as in Example 1 using the same carrier core particles as used in Example 1 except that titanium dioctyloxy bis(octylene glycolate) was used as a titanium chelate in an amount of 25.0% by weight based on coating resin solids, and 3-glycidoxypropyltrimetoxysilane was used as an adhesion improver in an amount of 12.0% by weight based on coating resin solids, as shown in Tables 1 and 2.

### Example 17

A resin-coated carrier for an electrophotographic developer was produced in the same manner as in Example 1 using the same carrier core particles as used in Example 1 except that vinyltris(methylethylketoxime)silane (VTO) was used as a crosslinking agent in an amount of 1.0% by weight based on coating resin solids, as shown in Tables 1 and 2.

### Example 18

A resin-coated carrier for an electrophotographic developer was produced in the same manner as in Example 1 using the same carrier core particles as used in Example 1 except that a crosslinking agent was not used, as shown in Tables 1 and 2.

### Example 19

A resin-coated carrier for an electrophotographic developer was produced in the same manner as in Example 1 using the same carrier core particles as used in Example 1 except that methyltris(methylethylketoxime)silane (MTO) was used as a crosslinking agent in an amount of 0.05% by weight based on coating resin solids, as shown in Tables 1 and 2.

### Example 20

A resin-coated carrier for an electrophotographic developer was produced in the same manner as in Example 1 using the same carrier core particles as used in Example 1 except that methyltris(methylethylketoxime)silane (MTO) was used as a crosslinking agent in an amount of 10.0% by weight based on coating resin solids, as shown in Tables 1 and 2.

### Example 21

A resin-coated carrier for an electrophotographic developer was produced in the same manner as in Example 1 using the same carrier core particles as used in Example 1 except that methyltris(methylethylketoxime)silane (MTO) was used as a crosslinking agent in an amount of 12.0% by weight based on coating resin solids, as shown in Tables 1 and 2.

### Example 22

A resin-coated carrier for an electrophotographic developer was produced in the same manner as in Example 1 using the same carrier core particles as used in Example 1 except that an acryl-modified silicone resin was used as a coating resin, and the coating amount of the acryl-modified silicone resin was 1.5% by weight based on the carrier core particles, as shown in Tables 1 and 2.

### Example 23

A resin-coated carrier for an electrophotographic developer was produced in the same manner as in Example 1 using the same carrier core particles as used in Example 1 except that a fluorine-modified silicone resin was used as a coating resin, and the coating amount of the fluorine-modified silicone resin was 1.5% by weight based on the carrier core particles, as shown in Tables 1 and 2.

### Comparative Example 1

A resin-coated carrier for an electrophotographic developer was produced in the same manner as in Example 1 using the same carrier core particles as used in Example 1 except that titanium tetraacetylacetonate was used as a titanium chelate in an amount of 25.0% by weight based on coating resin solids, as shown in Tables 1 and 2.

### Comparative Example 2

A resin-coated carrier for an electrophotographic developer was produced in the same manner as in Example 1 using the same carrier core particles as used in Example 1 except that titanium diisopropoxy bis(acetylacetonate) was used as a titanium chelate in an amount of 25.0% by weight based on coating resin solids, as shown in Tables 1 and 2.

### Comparative Example 3

A resin-coated carrier for an electrophotographic developer was produced in the same manner as in Example 1 using the same carrier core particles as used in Example 1 except that titanium diisopropoxy bis(ethyl acetoacetate) was used as a titanium chelate in an amount of 2.5% by weight based on coating resin solids, as shown in Tables 1 and 2.

### Comparative Example 4

A resin-coated carrier for an electrophotographic developer was produced in the same manner as in Example 1 using the same carrier core particles as used in Example 1 except that titanium diisopropoxy bis(ethyl acetoacetate) was used as a titanium chelate in an amount of 60.0% by weight based on coating resin solids, as shown in Tables 1 and 2.

An electrophotographic developer was prepared in the same manner as in Example 1 for each of the resin-coated carriers for an electrophotographic developer from Examples 2 to 23 and Comparative Examples 1 to 4 to measure the initial charge amount.

Table 1 shows the coating resins (type, coating amount), the crosslinking agents (type, content), and the titanium chelates (type, content) used for the resin-coated carriers in Examples 1 to 23 and Comparative Examples 1 to 4, and Table 2 shows the charge control agents (type, content) and the adhesion improvers (type, content). Further, Table 3 shows the charge amount (initial, after 48 hours, rate of change caused by environmental change, rate of change caused by toner density variation) and the overall evaluation of the resin-coated carriers in Examples 1 to 23 and Comparative Examples 1 to 4. The measuring methods and evaluation methods thereof are as follows.

### (Charge Amount)

The charge amount was determined by measuring the initial charge amount and the charge amount after 48 hours using Epping q/m-meter, a suction type charge amount measuring apparatus manufactured by PES-Laboratoriumu (mesh: 795 mesh, suction pressure: 105±10 mbar, suction time: 90 seconds). Furthermore, the rate of change caused by environmental change and the rate of change caused by toner density variation were determined based on the expressions to be described below. In the following expressions, HH represents high temperature and high humidity (a temperature of 30 to 35° C. and a relative humidity of 80 to 85%); LL represents low temperature and low humidity (a temperature of 10 to 15° C. and a relative humidity of 10 to 15%); and T/D represents the toner density based on the developer.

### (The Rate of Change Caused by Environmental Change)

The rate of change caused by environmental change (%)=100−(Charge amount in HH environment)/Charge amount in LL environment)×100

### (The Rate of Change Caused by Toner Density Variation)

The rate of change caused by toner density variation=(Charge amount at T/D=9.0 wt %)/(Charge amount at T/D=6.0 wt %)×100

### (Overall Evaluation)

The overall evaluation was made by the three stages of good (A), fair (B), and poor (C).

TABLE 1

| | Coating resin | | Crosslinking agent *1 | | Titanium chelate | |
|---|---|---|---|---|---|---|
| | | Coating amount | | Content | | Content |
| | Type | (wt %) *2 | Type | (wt %) *3 | Type | (wt %) *3 |
| Ex. 1 | Methyl silicone resin | 1.5 | MTO | 1 | Titanium diisopropoxy bis(ethyl acetoacetate) | 25 |
| Ex. 2 | Methyl silicone resin | 1.5 | MTO | 1 | Titanium diisopropoxy bis(ethyl acetoacetate) | 5 |
| Ex. 3 | Methyl silicone resin | 1.5 | MTO | 1 | Titanium diisopropoxy bis(ethyl acetoacetate) | 50 |
| Ex. 4 | Methyl silicone resin | 1.5 | MTO | 1 | Titanium dioctyloxy bis(octylene glycolate) | 25 |
| Ex. 5 | Methyl silicone resin | 1.5 | MTO | 1 | Titanium diisopropoxy bis(ethyl acetoacetate) | 25 |
| Ex. 6 | Methyl silicone resin | 1.5 | MTO | 1 | Titanium diisopropoxy bis(ethyl acetoacetate) | 25 |
| Ex. 7 | Methyl silicone resin | 1.5 | MTO | 1 | Titanium dioctyloxy bis(octylene glycolate) | 25 |
| Ex. 8 | Methyl silicone resin | 1.5 | MTO | 1 | Titanium diisopropoxy bis(ethyl acetoacetate) | 25 |
| Ex. 9 | Methyl silicone resin | 1.5 | MTO | 1 | Titanium diisopropoxy bis(ethyl acetoacetate) | 25 |
| Ex. 10 | Methyl silicone resin | 1.5 | MTO | 1 | Titanium dioctyloxy bis(octylene glycolate) | 25 |
| Ex. 11 | Methyl silicone resin | 1.5 | MTO | 1 | Titanium diisopropoxy bis(ethyl acetoacetate) | 25 |
| Ex. 12 | Methyl silicone resin | 1.5 | MTO | 1 | Titanium diisopropoxy bis(ethyl acetoacetate) | 25 |
| Ex. 13 | Methyl silicone resin | 1.5 | MTO | 1 | Titanium dioctyloxy bis(octylene glycolate) | 25 |
| Ex. 14 | Methyl silicone resin | 1.5 | MTO | 1 | Titanium diisopropoxy bis(ethyl acetoacetate) | 25 |
| Ex. 15 | Methyl silicone resin | 1.5 | MTO | 1 | Titanium diisopropoxy bis(ethyl acetoacetate) | 25 |
| Ex. 16 | Methyl silicone resin | 1.5 | MTO | 1 | Titanium dioctyloxy bis(octylene glycolate) | 25 |
| Ex. 17 | Methyl silicone resin | 1.5 | VTO | 1 | Titanium diisopropoxy bis(ethyl acetoacetate) | 25 |
| Ex. 18 | Methyl silicone resin | 1.5 | — | — | Titanium diisopropoxy bis(ethyl acetoacetate) | 25 |
| Ex. 19 | Methyl silicone resin | 1.5 | MTO | 0.05 | Titanium diisopropoxy bis(ethyl acetoacetate) | 25 |
| Ex. 20 | Methyl silicone resin | 1.5 | MTO | 10 | Titanium diisopropoxy bis(ethyl acetoacetate) | 25 |
| Ex. 21 | Methyl silicone resin | 1.5 | MTO | 12 | Titanium diisopropoxy bis(ethyl acetoacetate) | 25 |
| Ex. 22 | Acryl-modified silicone resin | 1.5 | MTO | 1 | Titanium diisopropoxy bis(ethyl acetoacetate) | 25 |
| Ex. 23 | Fluorine-modified silicone resin | 1.5 | MTO | 1 | Titanium diisopropoxy bis(ethyl acetoacetate) | 25 |
| Com. Ex. 1 | Methyl silicone resin | 1.5 | MTO | 1 | Titanium tetraacetylacetonate | 25 |
| Com. Ex. 2 | Methyl silicone resin | 1.5 | MTO | 1 | Titanium diisopropoxy bis(acetylacetonate) | 25 |
| Com. Ex. 3 | Methyl silicone resin | 1.5 | MTO | 1 | Titanium diisopropoxy bis(ethyl acetoacetate) | 2.5 |
| Com. Ex. 4 | Methyl silicone resin | 1.5 | MTO | 1 | Titanium diisopropoxy bis(ethyl acetoacetate) | 60 |

*1: MTO; Methyltris(methylethylketoxime)silane, VTO; Vinyltris(methylethylketoxime)silane
*2: The amount based on carrier core particles
*3: The amount based on coating resin

TABLE 2

| | Charge control agent | | Adhesion improver | |
|---|---|---|---|---|
| | | Content (wt %) *3 | | Content (wt %) *3 |
| | Type | (wt %) | Type | (wt %) |
| Ex. 1 | 3-Aminopropyltriethoxysilane | 15 | 3-Glycidoxypropyltrimetoxysilane | 1 |
| Ex. 2 | 3-Aminopropyltriethoxysilane | 15 | 3-Glycidoxypropyltrimetoxysilane | 1 |
| Ex. 3 | 3-Aminopropyltriethoxysilane | 15 | 3-Glycidoxypropyltrimetoxysilane | 1 |
| Ex. 4 | 3-Aminopropyltriethoxysilane | 15 | 3-Glycidoxypropyltrimetoxysilane | 1 |
| Ex. 5 | N-2(Aminoethyl)-3- | 15 | 3-Glycidoxypropyltrimetoxysilane | 1 |
| | aminopropyltrimethoxysilane | | | |
| Ex. 6 | Quaternary ammonium salt complex | 15 | 3-Glycidoxypropyltrimetoxysilane | 1 |
| Ex. 7 | — | — | 3-Glycidoxypropyltrimetoxysilane | 1 |
| Ex. 8 | 3-Aminopropyltriethoxysilane | 1 | 3-Glycidoxypropyltrimetoxysilane | 1 |
| Ex. 9 | 3-Aminopropyltriethoxysilane | 30 | 3-Glycidoxypropyltrimetoxysilane | 1 |
| Ex. 10 | 3-Aminopropyltriethoxysilane | 40 | 3-Glycidoxypropyltrimetoxysilane | 1 |
| Ex. 11 | 3-Aminopropyltriethoxysilane | 15 | (3-Glycidoxypropyl)methyldiethoxysilane | 1 |
| Ex. 12 | 3-Aminopropyltriethoxysilane | 15 | 2-(3, 4-Epoxycyclohexyl)ethyltrimethoxysilane | 1 |
| Ex. 13 | 3-Aminopropyltriethoxysilane | 15 | — | — |
| Ex. 14 | 3-Aminopropyltriethoxysilane | 15 | 3-Glycidoxypropyltrimetoxysilane | 0.05 |
| Ex. 15 | 3-Aminopropyltriethoxysilane | 15 | 3-Glycidoxypropyltrimetoxysilane | 10 |
| Ex. 16 | 3-Aminopropyltriethoxysilane | 15 | 3-Glycidoxypropyltrimetoxysilane | 12 |
| Ex. 17 | 3-Aminopropyltriethoxysilane | 15 | 3-Glycidoxypropyltrimetoxysilane | 1 |
| Ex. 18 | 3-Aminopropyltriethoxysilane | 15 | 3-Glycidoxypropyltrimetoxysilane | 1 |
| Ex. 19 | 3-Aminopropyltriethoxysilane | 15 | 3-Glycidoxypropyltrimetoxysilane | 1 |
| Ex. 20 | 3-Aminopropyltriethoxysilane | 15 | 3-Glycidoxypropyltrimetoxysilane | 1 |
| Ex. 21 | 3-Aminopropyltriethoxysilane | 15 | 3-Glycidoxypropyltrimetoxysilane | 1 |
| Ex. 22 | 3-Aminopropyltriethoxysilane | 15 | 3-Glycidoxypropyltrimetoxysilane | 1 |
| Ex. 23 | 3-Aminopropyltriethoxysilane | 15 | 3-Glycidoxypropyltrimetoxysilane | 1 |
| Com. Ex. 1 | 3-Aminopropyltriethoxysilane | 15 | 3-Glycidoxypropyltrimetoxysilane | 1 |
| Com. Ex. 2 | 3-Aminopropyltriethoxysilane | 15 | 3-Glycidoxypropyltrimetoxysilane | 1 |
| Com. Ex. 3 | 3-Aminopropyltriethoxysilane | 15 | 3-Glycidoxypropyltrimetoxysilane | 1 |
| Com. Ex. 4 | 3-Aminopropyltriethoxysilane | 15 | 3-Glycidoxypropyltrimetoxysilane | 1 |

*3: The amount based on coating resin

TABLE 3

| | Charge amount | | | | | | | | | |
|---|---|---|---|---|---|---|---|---|---|---|
| | | | | | | Rate of change | | | Rate of change | |
| | | After | Charge | L/L | H/H | caused by | | | caused by | |
| | Initial | 48 hours | amount | environment | environment | environmental | T/D = 6.0% | T/D = 9.0% | toner density | Overall |
| | (μC/g) | (μC/g) | difference | (μC/g) | (μC/g) | change (%) | (μC/g) | (μC/g) | variation (%) | evaluation |
| Ex. 1 | 35.7 | 26.1 | 9.6 | 32.6 | 25.2 | 22.6 | 30 | 25.4 | 84.8 | A |
| Ex. 2 | 39.7 | 36.4 | 3.3 | 42.6 | 26.6 | 37.6 | 41.9 | 32.2 | 76.8 | A |
| Ex. 3 | 35.2 | 22.9 | 12.3 | 28.7 | 22 | 23.2 | 27.5 | 22.6 | 82.3 | A |
| Ex. 4 | 30.7 | 20.5 | 10.2 | 25.6 | 19.5 | 23.7 | 23.5 | 20 | 84.8 | A |
| Ex. 5 | 40.7 | 30.6 | 10.1 | 38.2 | 30.2 | 21 | 35.2 | 29.8 | 84.8 | A |
| Ex. 6 | 29.7 | 19.7 | 10 | 24.6 | 19.4 | 21.2 | 22.6 | 19.2 | 84.8 | B |
| Ex. 7 | 27.2 | 18.8 | 8.4 | 23.5 | 18.4 | 21.5 | 21.6 | 18 | 83.2 | B |
| Ex. 8 | 30.7 | 22.2 | 8.5 | 27.7 | 22 | 20.4 | 25.5 | 19.2 | 75.5 | A |
| Ex. 9 | 43.2 | 30.5 | 12.7 | 41 | 27.2 | 33.7 | 37.7 | 32.1 | 85.2 | A |
| Ex. 10 | 48.2 | 29.6 | 18.6 | 42.6 | 23.8 | 44.1 | 39.2 | 33.4 | 85.3 | B |
| Ex. 11 | 35.7 | 26.2 | 9.5 | 32.7 | 26.1 | 20.1 | 30.1 | 25.5 | 84.8 | A |
| Ex. 12 | 34.7 | 24.7 | 10 | 30.8 | 24.2 | 21.4 | 28.4 | 24.1 | 84.8 | A |
| Ex. 13 | 35.6 | 19.7 | 15.9 | 24.6 | 18.5 | 24.9 | 22.7 | 19.5 | 86.1 | B |
| Ex. 14 | 35.6 | 24.7 | 10.9 | 30.9 | 23.7 | 23.4 | 28.1 | 24.1 | 85.8 | A |
| Ex. 15 | 36.6 | 26.7 | 9.9 | 31.4 | 15.8 | 49.8 | 30.5 | 22.7 | 74.4 | A |
| Ex. 16 | 36.8 | 27.1 | 9.7 | 33.9 | 14 | 58.7 | 31.2 | 22.2 | 71.1 | B |
| Ex. 17 | 34.7 | 24.8 | 9.9 | 31 | 24.2 | 21.7 | 28.5 | 24.2 | 84.8 | A |
| Ex. 18 | 35.6 | 21.6 | 14 | 27 | 19.8 | 26.6 | 24.9 | 21.4 | 86.1 | B |
| Ex. 19 | 35.6 | 24.7 | 10.9 | 30.9 | 23 | 25.7 | 28.4 | 24.5 | 86 | A |
| Ex. 20 | 36.6 | 26.7 | 9.9 | 33.4 | 23 | 31.2 | 30.7 | 22.6 | 73.6 | A |
| Ex. 21 | 36.8 | 26.9 | 9.9 | 33.6 | 25.4 | 24.5 | 30.9 | 22 | 71.1 | B |
| Ex. 22 | 35.7 | 26.8 | 8.9 | 33.5 | 25.8 | 22.8 | 30.8 | 26.1 | 84.8 | A |
| Ex. 23 | 35.7 | 25 | 10.7 | 31.2 | 24 | 23 | 28.7 | 24.4 | 84.8 | A |
| Com. Ex. 1 | 32.7 | 21.9 | 10.8 | 27.3 | 9.1 | 66.8 | 25.1 | 16.3 | 64.8 | C |
| Com. Ex. 2 | 28.7 | 17.5 | 11.2 | 21.8 | 6.6 | 69.8 | 20.1 | 13 | 64.8 | C |
| Com. Ex. 3 | 40.6 | 36.4 | 4.2 | 42.7 | 8.1 | 80.9 | 37.9 | 31.6 | 83.4 | C |
| Com. Ex. 4 | 35.1 | 13.5 | 21.6 | 16.9 | 12.3 | 27.5 | 15.5 | 13.4 | 86 | C |

As apparent from the results shown in Table 3, the reduction in the charge amount after 48 hours was small, and the rate of change caused by environmental change and the rate of change caused by toner density variation were generally good, in Examples 1 to 23.

On the other hand, the rate of change caused by environmental change and the rate of change caused by toner density variation were poor in Comparative Examples 1 to 3, and the reduction in the charge amount after 48 hours was large in Comparative Example 4, all having difficulty in use.

The resin-coated carrier for an electrophotographic developer according to the present invention and the electrophotographic developer using the same provide high durability, show little reduction in the charge amount even after a prolonged use, and are excellent in the environmental stability of the charge amount, and broadly correspond to the printing rate variation and toner density variation accompanying full colorization and provide a stable image quality.

Accordingly, the resin-coated carrier for an electrophotographic developer according to the present invention and the electrophotographic developer using the same can be widely used in the fields of full color machines requiring high image quality, high speed machines requiring reliability and durability of image maintenance, and the like.

1. A resin-coated carrier for an electrophotographic developer, comprising:
a carrier core particle; and
a coating resin layer comprising a silicone resin or a modified silicone resin formed on a surface of the carrier core particle,
wherein a titanium-ethyl acetoacetate chelate or a titanium-octylene glycol chelate is contained in the coating resin layer as a titanium chelate, and
wherein the content of the titanium-ethyl acetoacetate chelate or the titanium-octylene glycol chelate is 5.0 to 50.0% by weight based on coating resin solids.

2. The resin-coated carrier for an electrophotographic developer according to claim 1, wherein a charge control agent, an adhesion improver, and a crosslinking agent are contained in the coating resin layer.

3. The resin-coated carrier for an electrophotographic developer according to claim 2, wherein the charge control agent is an aminosilane coupling agent, the content thereof being 1.0 to 30.0% by weight based on coating resin solids; the adhesion improver is an epoxy group-containing silane coupling agent, the content thereof being 0.05 to 10.0% by weight based on coating resin solids; and the crosslinking agent is methyltris(methylethylketoxime)silane and/or vinyltris(methylethylketoxime)silane, the content thereof being 0.05 to 10.0% by weight based on coating resin solids.

4. An electrophotographic developer comprising a resin-coated carrier according to claim 1 and toner.

5. The electrophotographic developer according to claim 4, wherein the electrophotographic developer is used as a refill developer.

6. An electrophotographic developer comprising a resin-coated carrier according to claim 2 and toner.

7. The electrophotographic developer according to claim 6, wherein the electrophotographic developer is used as a refill developer.

8. An electrophotographic developer comprising a resin-coated carrier according to claim 3 and toner.

9. The electrophotographic developer according to claim 8, wherein the electrophotographic developer is used as a refill developer.
